(19) United States
(12) Patent Application Publication
(10) Pub. No.: US 2012/0098371 A1
(43) Pub. Date: Apr. 26, 2012

(54) STABILIZATION OF ROTATING MACHINERY

(75) Inventors: John Michael Pinneo, Portola Valley, CA (US); Jonathan Forrest Garber, Hillsborough, CA (US)

(73) Assignee: SPINLECTRIX INC., Hillsborough, CA (US)

(21) Appl. No.: 13/280,314

(22) Filed: Oct. 24, 2011

Related U.S. Application Data
(60) Provisional application No. 61/406,102, filed on Oct. 22, 2010.

(51) Int. Cl. H02K 7/09

(52) U.S. Cl. 310/90.5

(57) ABSTRACT

This invention improves the operation of rotating machinery by allowing rotation about an inertial axis without the generation of imbalance forces that arise from the use of bearings to support rotating components.

### CROSS-REFERENCE TO RELATED APPLICATIONS

This application claims priority to U.S. Provisional Application 61/406,103 filed Oct. 22, 2010, entitled “Methods for Stabilization of Flywheels,” U.S. Provisional Application 61/406,102 filed Oct. 22, 2010, entitled “Method of Stabilization of Rotating Machinery,” U.S. Provisional Application 61/406,105 filed Oct. 22, 2010, entitled “Permanent Magnets for Flywheels,” U.S. Provisional Application 61/406,099 filed Oct. 22, 2010, entitled “Flywheel Structures,” U.S. Provisional Application 61/406,104 filed Oct. 22, 2010, entitled “Kinetic Energy Storage Rotor Design,” and U.S. Provisional Application 61/406,107 filed Oct. 22, 2010, entitled “Concrete Vacuum Enclosures for Energy Storage Flywheels.” Each of these references are incorporated herein

### BACKGROUND OF THE INVENTION

1. The Field of the Invention

The present invention relates to rotating machinery. More particularly, the present invention relates to improved systems and methods for maintaining stability in rotation machinery.

2. The Relevant Technology

Many useful devices employ rotating components. Examples include turbines, wheels, motors, and flywheels. Such rotating machinery routinely incorporates bearings in order to confine rotating components to an axis of rotation which is fixed in a desired position with respect to adjacent nonrotating components. Thus, bearings are typically needed to ensure the stable operation of rotating components. Bearings have been used to stabilize rotating machinery since the first known steam turbine, the Aeolipile, was described by Hero of Alexandria in the first century, A.D.

In the context of this invention, a defining characteristic of a bearing is that it constrains rotation of the body on which it operates to a particular axis as defined by placement and construction of the bearings, and this axis is termed a geometric axis of rotation, a geometric locus of rotation, or the like. As discussed below, because bearings constrain a body's rotation to a geometric axis, forces arise among the rotating body, its bearings, and the bearings' supports that are unique to the use of bearings as supports for spinning bodies.

It has long been known that bodies spinning without constraint rotate about an axis that is determined by their unique mass properties, in particular the mass distribution of the body. Such an axis is termed an inertial axis of rotation. Although solid bodies possess three inertial axes of rotation, one each for the three spatial dimensions X, Y, and Z, we will discuss here a single inertial axis, the principles of this invention being equally applicable to any inertial axis. Examples of unconstrained rotation about an inertial axis include spinning bullets shot from firearms having rifled barrels (neglecting aerodynamic effects), and spin-stabilized satellites.

The inertial and geometric rotational axes of a rotating body need not, and often do not, coincide. Two nonidentical axes may intersect at a point, may be parallel and nonintersecting, or may be nonparallel and nonintersecting, according to the particulars of the body's mass distribution (which determines the inertial rotational axis) and the bearings supporting the body (which determine a geometric rotational axis).

It is impractical to fabricate rotating components having identical geometric and inertial rotational axes. The difference between a rotating body's geometric and inertial rotational axes causes imbalance forces to arise when the body is constrained by bearings to rotate on a geometric axis, according to the degree and type of difference between the two axes.

When considering a body in rotation about the Z-axis in a Cartesian coordinate system, a bearing-supported unbalanced body develops a force that acts on its bearings and their supports and that varies synchronously with the body's rotational position or phase. This force can be decomposed into x- and y-axis components according to the following relationships:

Fₓ=MDω²cosωt

and

F_{y}=MDω²sinωt

where the variable M represents the rotating body's moment of inertia about the Z-axis, the variable D represents the distance between the body's inertial and geometric rotational axes, the variable ω represents the body's rotation rate in radians/second, and the variable t represents time. It will be apparent to those skilled in the art that D may describe a simple displacement between two parallel inertial and geometric rotational axes, or may describe a more complex non-parallel circumstance that may or may not include an intersection of the two axes, according to conditions as depicted in FIGS. 1A-1D.

More particularly, as shown in FIGS. 1A-1D, a rotating body 2 rotates in free space. The rotating body 2 has a shaft 4 that is substantially collinear with a geometric axis of rotation 3 which is defined by bearings 5. In FIG. 1A, the rotating body 2 has an inertial axis of rotation 6, which lies parallel to the Z-axis of the coordinate system 1. As described above, ideally the geometric axis of rotation 3 is identical to the inertial axis of rotation 6, but as shown in FIG. 1A, the inertial axis of rotation 6 is often slightly displaced form the geometric axis of rotation 3. FIG. 1B illustrates a rotating body 2 which has an inertial axis of rotation 6 which lies parallel to the Z-axis, but which is displaced in the negative direction along the X-axis from the geometric axis 3 of rotation. FIG. 1C illustrates a third alternative, where the rotating body 2 has an inertial axis of rotation 6 which is not parallel to the Z-axis and which is displaced from the geometric axis of rotation 3 by an angular rotation about the Y-axis. Finally, FIG. 1D illustrates yet another example where the rotating body 2 has an inertial axis of rotation 6 which is not parallel to the Z-axis and which is displaced from the geometric axis of rotation 3 by an angular rotation about the Y-axis, a negative direction of the X-axis, and a negative axis of the Z-axis.

FIG. 2 illustrates a rotating body 2 with an inertial axis of rotation 6, which is parallel to, but displaced in the negative x direction from, the rotating body's 2 geometric center 2a, which contains its geometric rotation axis 3. The rotating body's 2 rotation about the Z axis is indicated by 7. FIG. 3 depicts an end view of a rotating body 2 attached to a shaft 4, with the body's geometric center and geometric axis of rotation 3 being coincident and represented with a single cross symbol. The adjacent inertial axis of rotation 6 is displaced from the geometric rotational axis 3 in the negative direction along the X-axis, represented by an X symbol. For clarity, ball bearing elements have been omitted from this figure, but should be considered to be disposed about the shaft 4 as depicted in FIG. 2. Rotation about the Z axis of coordinate system 1 is indicated by 7.

FIG. 4 depicts coordinate system 1 and a rotating body 2 spinning as depicted by 7 on bearings (omitted for clarity) about its geometric axis of rotation 3 which is coincident with its geometric center 2a, having a separation distance D between that geometric axis of rotation 3 and its inertial axis of rotation 6. As discussed briefly above, the inertial axis of rotation 6 is defined by the body's mass properties and which describes a rotational path 9 about the geometric axis of rotation 3. For clarity, bearings and shaft elements are omitted from this view.

In contrast to the rotation that exists when the rotation is confined by bearings, FIG. 5 depicts coordinate system 1 and a rotating body 2 which has a tendency to rotate about its inertial axis of rotation 6 as indicated by feature 9, with a geometric center 2a coincident with its geometric axis of rotation 3. The displacement along the x-axis between the inertial rotational axis 6 and the geometric center 2a is shown as the distance D in FIG. 5. Element 9a depicts the apparent motion described by the geometric center point as the body rotates about its inertial axis of rotation 6. Rotation feature 7 indicates the body's apparent rotation as it rotates about its inertial axis of rotation 6.

As is evident from these relationships, imbalance forces on the bearings vary linearly with the distance between inertial and geometric rotational axes and vary as the square of the rotation rate w. At high rotation rates, even minor differences between the inertial and geometric rotational axes can produce large forces that act on supporting bearings and are transmitted to the bearings' nonrotating support structures.

In summary, the use of bearings to support spinning bodies generates forces that:

act on the spinning body, its bearings, and the bearings' interface with the nonrotating environment;

vary linearly in magnitude with the displacement between a body's inertial rotational axis and its geometric rotational axis;

vary as the square of the body's rotation rate;

are fundamentally synchronized to the body's rotation, with a phase displacement that arises from the well-known effects of gyroscopic precession inherent to all spinning bodies;

arise as a result of a body rotating while being constrained to a geometric rotational axis.

These combined qualities distinguish imbalance forces that arise with use of bearings to support spinning bodies from all other forces to which such bodies are subject. The set of these qualities is useful in determining whether a particular rotating system includes elements that function as bearings, regardless of their particular implementation.

Imbalance forces often limit the rotational speed of a rotating component and limit the component's operational life by causing wear in its supporting bearings. Because imbalance forces are synchronous with the component's rotation, they can excite adverse vibrations in the rotating component, its bearings, and in its support. Resonance effects can permit vibration-induced deflections to cause failure of the rotating component, its bearings, or its support.

These imbalance forces differ from other forces that affect bearings, such as the force caused by gravity acting on a rotating body supported by bearings, or the forces that may arise from the effects on a rotating body of a surrounding viscous medium such air or water, which may exert forces that differ in character from imbalance forces. Such forces do not embody the particular set of characteristics that uniquely identify bearing-induced imbalance forces. They may or may not be synchronized with the spinning body's rotational phase. They may or may not vary with the body's rotation rate, and they may or may not vary with the location of the body's inertial axes, or with the difference between the body's inertial axes and constrained geometric axes of rotation.

Similarly, centrifugal forces that arise in spinning bodies by reason of their rotation are not synchronous with rotation, nor do they vary with respect to the difference between a body's inertial and geometric rotational axes.

In summary, the use of bearings to support a spinning body gives rise to a uniquely identifiable set of forces, and to unique limitations on the useful operation of a spinning body.

The imbalance forces can be reduced, but not eliminated, by modifying the rotating body's mass properties through a variety of balancing methods well known to persons skilled in the art. Increments of mass may be removed from or added to the rotating component to bring the inertial axis into closer coincidence with its geometric axis. The faster the component spins, the more finely it must be balanced to maintain imbalance forces within operable limits. Balancing increases the cost of rotating components and may present a prohibitive economic barrier to use of a rotating component in an otherwise feasible application.

It will be noted that imbalance forces can be created or modified by dynamic phenomena that alter a rotating body's mass distribution. One such phenomenon is asymmetric deformation, whether elastic or permanent, due to centrifugal force arising from rotation. Another such phenomenon is compositional change (e.g., material aging) in the material comprising a rotating body. A third such phenomenon is mechanical degradation of the rotating body (e.g., local failure in a region of stress that may modify the rotating body's mass distribution). These phenomena can give rise to imbalance forces for which remedial balancing methods are infeasible. In consequence, the maximum rotation rate of a spinning component may degrade over time.

With respect to bearings which are typically used to constrain rotating components, it will be appreciated that such bearings comprise a wide variety of configurations and modes of operation. Bearings are known, for example, which employ solid materials (as in sleeve or rolling element bearings), fluids (as in gas or liquid film bearings), or force fields (as in magnetic or electrostatic bearings). Bearings may further be classified according to whether they are passive (in that their characteristics derive from their basic mechanical configuration and properties, which may include damping, compliance, or other effects achievable by passive means), or active (in that their action is modulated by active controls, often incorporating sensing, computation, and effector functions).

Regardless of their particular configuration, all bearings that support a rotating body constrain that body's locus of rotation in at least one coordinate axis, and far more commonly in at least two coordinate axes.

The term “bearingless” is encountered in the art of rotating machinery and requires clarification. Most commonly, however, “bearingless” systems use magnetic suspension on rotating components, in which passive and/or active magnetic means are used to mitigate imbalance forces. On inspection, these “bearingless” systems are seen to exhibit the most basic function of a bearing, and thus still constrain a rotating body to spin about a defined geometric locus. Further, they exhibit the unique characteristic forces that accompany the interaction of spinning bodies and bearings, as discussed above.

The term, “bearingless,” thus refers to the absence of a bearing comprised of a more conventional material, not to the absence of bearings per se. This is noted in Chiba, et al., in their reference text “Magnetic Bearings and Bearingless Drives”, in which the authors opine that the definitions of a bearingless motor include “1. A motor with a magnetically integrated bearing function.” and “2. A magnetic bearing with a magnetically integrated motor function.” (Table 1.1, page 5). Additionally from the same reference, it may be seen on pages 3-4, with reference to FIGS. 1.2 and 1.3 and the relevant explanatory text, that the distinction between machines having magnetic bearings and those termed “bearingless” is that in the former, a motor, separate from the magnetic bearings, is employed to provide torque; in the latter, the motor function is integrated into the magnetic bearings. In a further example from Chiba, et al., FIG. 1.7 (page 11) depicts three configurations of “bearingless” rotating machines. Each depicted machine contains either magnetic bearings or mechanical bearings.

Further examples of this contradictory and inaccurate nomenclature may be found in a large number of research publications in the field that recite the term “bearingless” in describing rotating machines that, as noted in the selfsame publications, employ bearings. One example among many is the paper by Asama and Chiba, “Effect of Permanent-Magnet Passive Magnetic Bearing on a Two-Axis Actively Regulated Low-Speed Bearingless Motor” (IEEE Transactions on Energy Conversion, Vol. 26, No. 1, March 2011), whose title clearly illustrates that the connotation of “bearingless” as used in the field of rotating machinery conflicts with its denotation. The present invention embodies “bearingless” rotating machinery in the true sense of the word, that is, without elements that constrain one or more degrees of spatial freedom in a manner that generates restoring forces that are synchronized with the rotation of the spinning body.

Finally, the term “bearingless” has long been employed in the same inaccurate manner in patented inventions. The following presents a number of representative United States Patents that recite “bearingless” in their titles, as applied to various spinning bodies, along with the features of each invention that indicates its use of bearings, as defined in the foregoing discussion.

U.S. Pat. No. 3,122,101, entitled “Bearingless Pump” and issued in 1964, describes a fluid film disposed so as to constrain a pump rotor to a specified location. The flow of fluid through conical rotors separates the rotors from a surrounding housing and maintains the rotors in a fixed geometric relationship to the housing, replacing mechanical bearings with a fluid film that provides the same function.

U.S. Pat. No. 4,015,474 , entitled “Stabilizing Means for Rotor of Bearingless Flowmeter” and issued in 1977, does not offer an explanation of the stabilization phenomenon exhibited in the invention. However, a close reading of the patent indicates the phenomenon depends on the disposition of fluid jets and exhaust ports at critical and symmetric distances from a spinning ring rotor. Under these conditions, radial perturbation of the ring rotor away from the projected center of jet impingement would create pressure imbalances that would create a restoring force whose magnitude would vary linearly with the rotor displacement. This is therefore a particular instance of a fluid bearing.

U.S. Pat. No. 4,286,187, entitled “Bearingless Generator and Rotary Machine Combination” and issued in 1981, includes a generator element that is supported from the shaft of the engine that powers it, but which has no bearings dedicated solely to support of the rotating generator element. Because the inertial properties of the shaft-supported generator element are resolved at the bearings that support the shaft, this generator is supported by bearings and is not bearingless within the meaning described below.

U.S. Pat. No. 4,833,925, entitled “Bearingless Flowmeter,” issued in 1989, teaches a ring rotor component of a flowmeter which is intentionally unbalanced and which is found to operate more reliably than a flowmeter having a balanced ring because the unbalanced ring remains predictably within a particular wobbling mode of operation and does not transition unpredictably into other modes that provide inaccurate flow indications. In this invention, the unbalanced ring rotates within a solid housing that contains impinging fluid jets which both propel the ring and provide a fluid film bearing to stabilize its motion about a geometric axis. The rotor restoring force inherent in this configuration exhibits all the characteristics of bearing-related restorative forces as contemplated within the present invention. Hence, this flowmeter incorporates a bearing.

U.S. Pat. No. 5,482,432, entitled “Bearingless Automotive Coolant Pump with In-Line Drive,” issued in 1996 teaches a system which is similar to the invention in U.S. Pat. No. 4,286,187. The '432 invention is a coolant pump comprised of a drive element supported by bearings, which has an integral shaft to which is mounted a pump impeller that has no bearings solely dedicated to its support. As before, this impeller's inertial properties are resolved at the drive element's bearings, and the entire assembly is therefore supported by bearings. This invention is not bearingless within the meaning of the present invention.

U.S. Pat. No. 5,635,784, entitled “Bearingless Ultrasound-Sweep Rotor,” issued in 1997, describes a rotor comprising a reflective mirror that is centered (i.e., constrained to a particular location) by means of a two-axis passive magnetic bearing, and levitated to permit rotation by means of an actively controlled magnetic bearing. This invention embodies magnetic bearings, and illustrates the art's tendency to inaccurately characterize systems incorporating non-mechanical bearings as “bearingless”.

U.S. Pat. No. 6,034,456 , entitled “Compact Bearingless Machine Drive System,” issued in 2000, describes a machine that combines electric motor functions with magnetic bearings and in so doing improves upon the prior art which used discrete elements for those functions. Actively controlled stator windings provide radial restoring forces and torque that act on a suspended rotating shaft, thereby comprising a spinning body supported by bearings.

U.S. Pat. No. 6,071,093, entitled “Bearingless Blood Pump and Electronic Drive System,” issued in 2000 also teaches a “bearingless” system which is considered to include “bearings” as defined from the scope of the present invention. As noted in the Patent's abstract, in this invention “. . . concentric arrangements of cylinder magnets passively maintain radial centering . . . ” and “. . . the rotor is freely suspended such that blood washes over one or more surfaces of the rotor, and fluid pressure produces a net restoring force on the rotor to counteract changes in tile or axial position within the housing.”. The invention employs a combination of magnetic bearings and fluid bearings, and is therefore not in fact “bearingless”.

U.S. Pat. No. 6,078,119, entitled “Bearingless Rotary Machine,” issued in 2000, provides a means of stably controlling the position of an induction motor by magnetic levitation combined with a magnetic bearing function. As with all bearings, this invention confines the rotating body to a target, or specified position, as may be seen by inspection of FIG. 11 of the patent, which shows the invention's operation to control and minimize the deviation of a rotating shaft about a geometric rotational axis. Inspection of the control algorithm block diagrams presented in FIGS. 6-10 of the patent reveal derivation of radial restoring forces that vary with displacement from a desired geometric rotational axis. These are the operations of bearings, and the invention described is not “bearingless” within the meaning of our invention.

U.S. Pat. No. 6,727,618, entitled “Bearingless Switched Reluctance Motor,” issued in 2004, provides another illustration of misapplication of the term “bearingless.” As may be seen in the abstract “. . . A processor senses the position of the rotor and changes the flux to move the rotor toward center of the stator.”, indicating a confining of the rotor's spin axis to a geometric locus. In addition, claim 1 recites “A bearingless switched reluctance machine comprising: a stator having a plurality of poles . . . four of the . . . poles being levitation poles dedicated for use as a magnetic bearing . . . ”. The Patent does not describe a “bearingless” machine within the meaning of the present invention.

U.S. Pat. No. 7,456,537, entitled “Control System for Bearingless Motor-Generator,” issued in 2008, depicts yet another active magnetic bearing system that, in sum, exerts radial restoring forces on a rotor in proportion to the rotor's deviation from a defined geometric rotational axis. As can be seen in the discussion of the invention's control model (Column 6, lines 65-66), “. . . this control system provides simultaneous motor and magnetic bearing action.”. And although it is noted (Column 6, lines 60-62) that “The rotor 30 may be intentionally rotated around its center of mass instead of its geometric center . . . ”, the invention discloses no enablement of this modality, and in fact teaches away from this modality as shown by the Patent's FIG. 15 which shows the disappearance of the rotor's position deviation from the X-axis origin as a consequence of the invention's operation. The invention exemplifies an active magnetic bearing.

U.S. Pat. No. 7,750,492 B1, entitled “ Bearingless Floating Wind Turbine,” issued in 2010, also uses bearings, despite its title. As stated at Column 4, lines 37-39, “A number of bearings 21 are used between the inner shaft 13 and the central passage of the main support structure 11 to allow for smooth rotation between these two members.” These are mechanical bearings, and put this invention squarely within the class of rotating bodies that employ bearings.

U.S. Pat. No. 7,847,453 B2, entitled “Bearingless Step Motor,” issued in 2010, a means of constructing a step motor that contains a rotating shaft that can be levitated from a main body by magnetic force without using a mechanical bearing. As such, the invention's magnetic levitation system describes a magnetic bearing that provides shaft location capabilities equivalent to the mechanical bearing it supplants. This is an instance of inappropriate use of the term “bearingless” based on a misunderstanding of the fundamental common features of bearing operation.

Hence, all the so-called “bearingless” systems currently taught by the prior art have a bearing or other means whereby the rotating body's rotation is constrained to rotating around a geometric axis. As described above, such configurations inevitably result in imbalance forces being created, which can limit the rotational speed of the rotating body and effect the longevity and effectiveness of the system. Thus, there is a need for a more effective and efficient method for operating rotating machinery.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

These and other limitations are overcome by embodiments of the invention which relate to systems and methods for improving and stabilizing the rotation of rotating machinery.

A first aspect of the invention is a system for rotating machinery. The system includes a rotating body having an inertial axis of rotation, a means for rotating the rotating body about its inertial axis, and a means for supporting the rotating body while it rotates around its inertial axis without confining the rotating body to rotate around a defined geometric axis of rotation.

A second aspect of the invention is a system for stabilization of rotating machinery. The system includes a rotating body having an inertial axis of rotation, said rotating body having a displacement between its inertial axis of rotation and a defined geometric axis of rotation, a means for rotating the rotating body about its inertial axis, and a means for supporting the rotating body while it rotates around its inertial axis without confining the rotating body to rotate around the defined geometric axis of rotation.

A third aspect of the invention is a method for stabilizing rotating machinery. The method comprises causing a rotating body having an inertial axis of rotation to rotate about its inertial axis of rotation, said rotating body having a displacement between its inertial axis of rotation and a defined geometric axis of rotation, and supporting the rotating body while it rotates around its inertial axis without confining the rotating body to rotate around the defined geometric axis of rotation.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter. It is an aspect of this invention that it substantially eliminates imbalance forces in rotating bodies that are components of machines.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-1D are cross-sectional side views which illustrate a rotating body rotating in free space which has displaced inertial axes of rotation and geometric axes of rotation;

FIGS. 2-5 are additional top views which illustrate a rotating body rotating in free space which have displaced inertial axes of rotation and geometric axes of rotation;

FIG. 6 is a cross-sectional view of a rotating motor or rotor as an example of a system which is capable of performing aspects of the invention;

FIG. 7 is a cross-sectional view along the Z-coordinate axis of the system illustrated in FIG. 6;

FIG. 8 illustrates an example of an electromagnetic coil which may be used in association with embodiments of the invention;

FIGS. 9A-9B illustrate a more detailed example of an electromagnetic coil which may be used in association with embodiments of the invention;

FIG. 10 illustrates position sensors which may be used in association with embodiments of the invention;

FIG. 11 illustrates a method for stabilizing rotating machinery according to one embodiment of the invention;

FIG. 12 illustrates a method for forming a magnet which could be used in association with embodiments of the invention;

FIG. 13 illustrates a rotating cylinder of the prior art;

FIGS. 14-18 illustrate alternative embodiments of materials which may be used in association with the rotating cylinder of the invention.

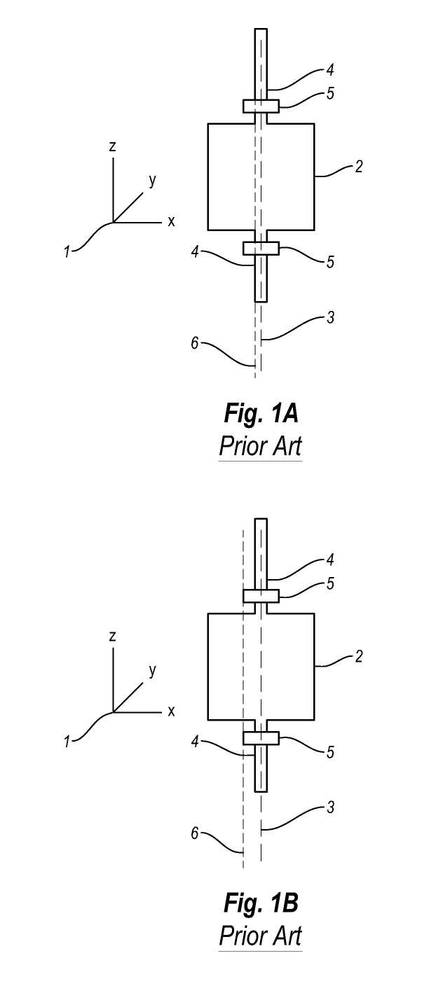

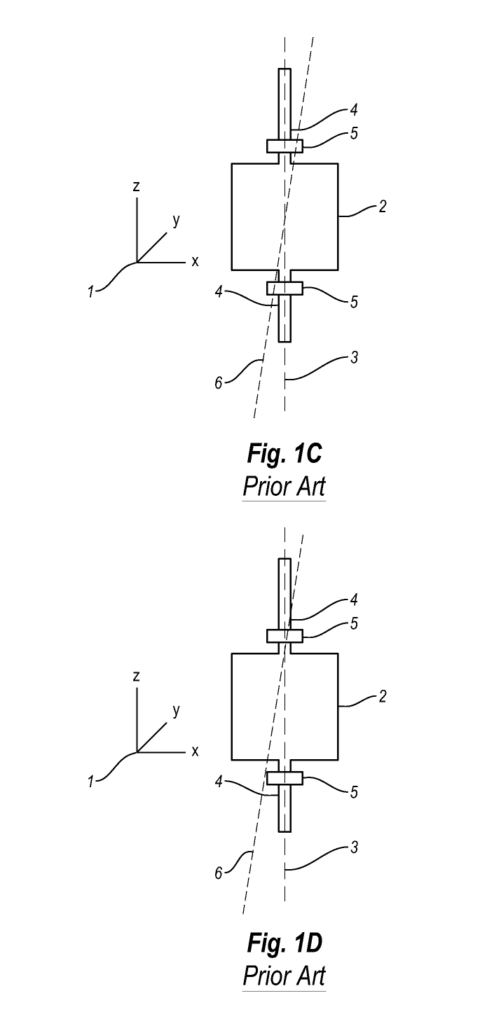

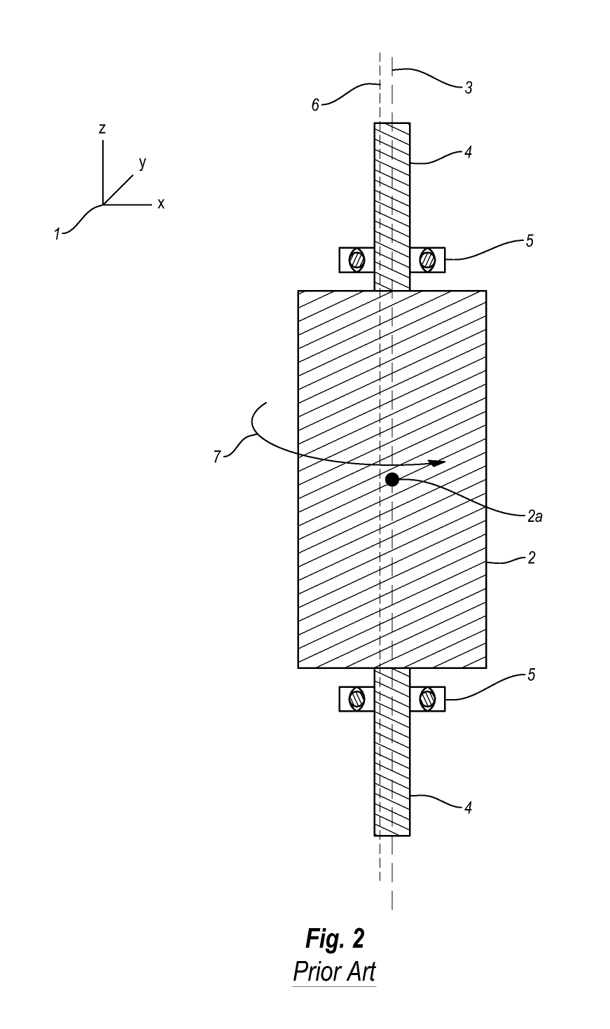

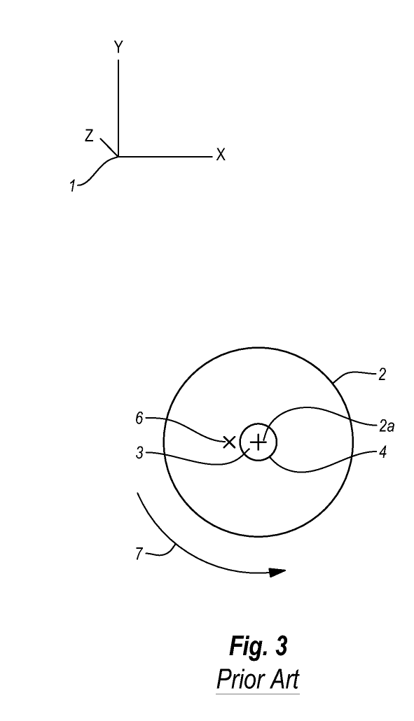

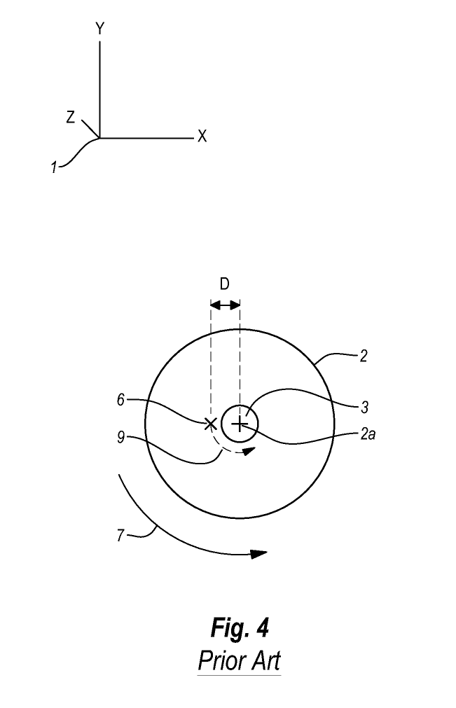

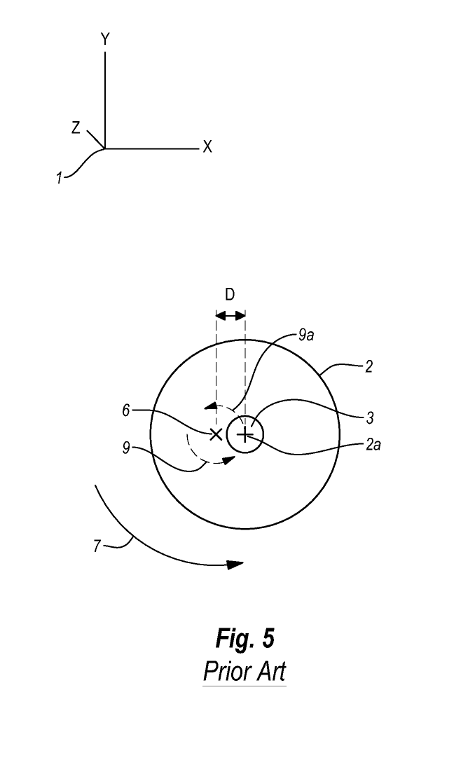

### DETAILED DESCRIPTION OF THE PREFERRED EMBODIMENTS

Embodiments of the invention relate to systems and methods for operating rotating machinery wherein the rotating body is able to rotate without bearings. Furthermore, as described below, the embodiments described herein enable to the rotating body to freely rotate about its inertial axis.

Although aspects of the invention are described herein with reference to a rotating motor/generator, it will be apparent to those skilled in the art that the invention is not limited to rotating motor/generator machines, and that the invention can be advantageously applied to other categories of rotating machines, including but not limited to, pumps, compressors, generators, motors, disc turbines, bladed turbines, and the like.

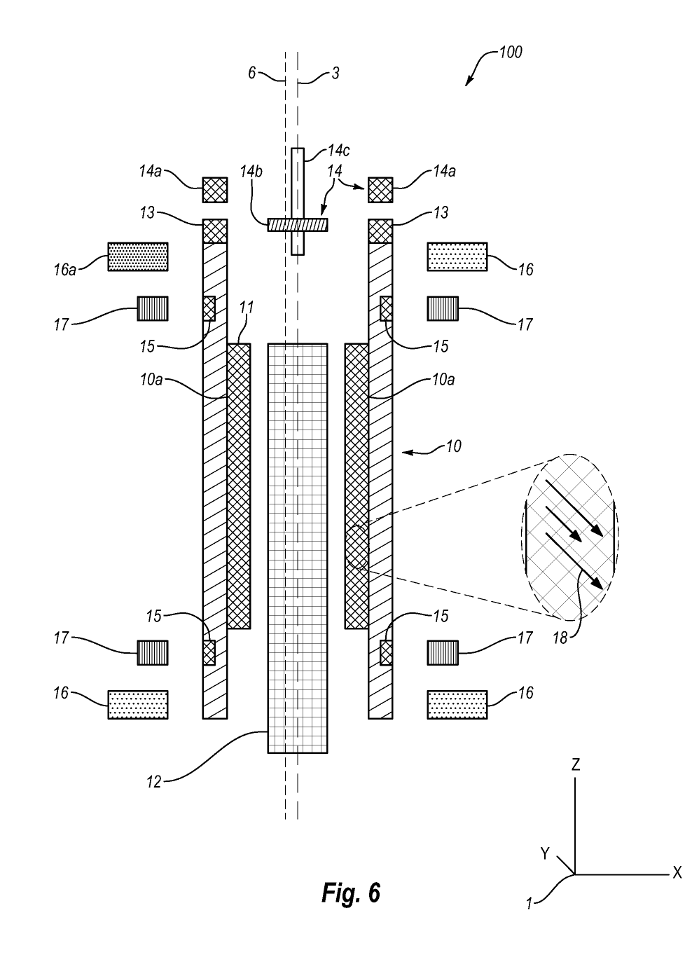

FIG. 6 is a cross-sectional view of a rotating motor 100 which resides in the coordinate system 1. The rotating motor 100 includes a rotating cylinder 10 containing a magnet array 11 which encloses an electromagnetic coil assembly 12. Also depicted is a lower levitation magnet 13, an upper levitation magnet assembly 14, positioning magnets 15, position sensors 16, and electromagnetic positioning actuators 17. The inertial axis of rotation 6 is displaced from and parallel to the geometric axis 5. Both axes are parallel to the Z axis coordinate.

In one embodiment, the rotating cylinder 10 is a hollow aluminum cylinder 10 which supports various affixed components as described below. In one embodiment, the aluminum cylinder 10 has an inner diameter of approximately five inches and an outer diameter of approximately six inches, although these dimensions are chosen to accommodate particular engineering requirements and are not limiting.

Furthermore, the material comprising the rotating cylinder 10 need not be aluminum, and other materials exhibiting appropriate properties compatible with the desired motor/generator function such as ceramics, fiber-reinforced composites, titanium, and other nonmagnetic alloys may be used.

As described above, the rotating cylinder 10 of FIG. 6 has a displacement between the inertial rotational axis 6 and the geometric rotational axis 3. In this example, the displacement between the inertial rotational axis 6 and the geometric rotational axis 3 is measured to be approximately 0.25 inches as determined by the mass distribution of the cylinder and its affixed components. As a result, when the rotating cylinder 10 is in unconstrained rotation about its inertial rotation axis 6, the geometric rotation axis 3 will describe a circle having a radius of 0.25 inches when observed by an observer who is stationary with respect to the rotating cylinder 10. Such an observer will also perceive the entire rotating cylinder as describing a geometrically eccentric rotation about its inertial rotational axis, with a radial geometric excursion of +/−0.25 inches. It will be apparent to those skilled in the art that the means by which the rotating cylinder 10 is supported with respect to its stationary environment must accommodate this geometric rotational eccentricity.

As will be described below, the rotating cylinder 10 is fixed in its location along the Z coordinate axis by means that do not inhibit its geometric eccentric runout in the X- and Y-axes as it spins about its inertial rotation axis 6, which is aligned parallel with the Z-axis.

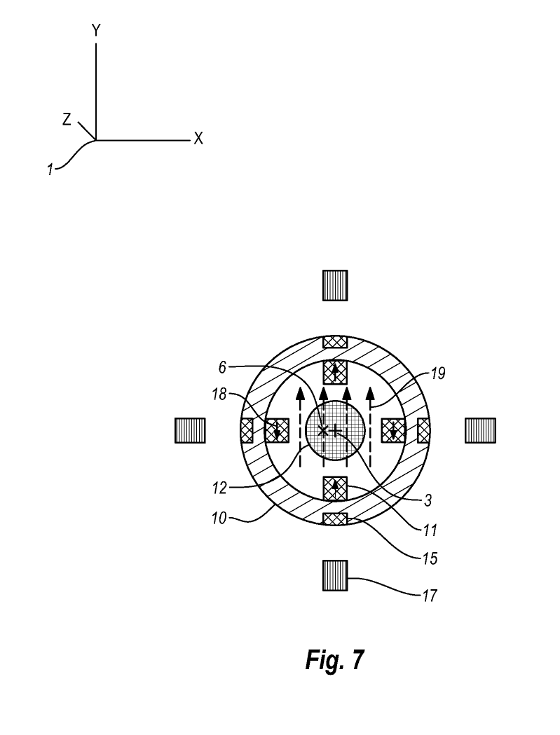

With reference to FIGS. 6 and 7, the rotating cylinder 10 in this example is hollow and as such is provided with an internal array of four magnets 11 disposed at 90 degree intervals around the inner circumference 10a of the aluminum cylinder 10. In magnet array 11, four magnets are oriented with their long axes parallel to the Z-axis in coordinate system 1, and with their magnetic orientations aligned as shown by arrows 18 in FIG. 6. One function of the magnet array 11 is to provide a permanent magnetic field against which magnetic fields generated by the operation of electromagnetic coil assembly 12 can react, imparting a torque to the rotating cylinder 10, thereby causing the rotating cylinder 10 to rotate about the Z coordinate axis. A second function of these magnets 11 is to provide a rotating permanent magnetic field that can induce currents in electromagnetic coil assembly 12, thereby causing kinetic energy stored in mass of rotating cylinder 10 and its affixed components to be transformed into electrical energy in the form of electrical currents flowing in electromagnetic coil assembly 12.

It will be apparent to those familiar with the art that magnet array 11 comprises an approximation of a Halbach array, in this instance a sparse Halbach array, which provides an approximately uniform dipole magnetic field within the volume enclosed by the magnet array 11 and which penetrates the electromagnetic coil assembly 12. Magnets comprising the magnet array 11 may be formed of any permanent magnetic material, including the well-known rare earth magnetic materials, as well as magnetic ceramics or ferrites, ALNICO, or other permanent magnetic materials. In a preferred embodiment, the magnets comprising magnet array 11 are composed of industry Grade 42 neodymium/iron/boron material and have dimensions of one inch×one inch×eight inches along the Z-axis. When affixed to the inner surface 10a of the rotating cylinder 10, the face-to-face distance between magnets 11 opposed across the cylinder diameter is approximately four inches. These magnets 11 may themselves be comprised of smaller magnets if desired.

It will be recognized that magnet array 11, acting in combination with electromagnetic coil assembly 12 and rotating cylinder 10 comprises the rotor of an electric motor/generator. The use of a sparse Halbach magnet array is a preferred embodiment and does not limit the scope of the following claims and other magnet configurations may advantageously be employed according to well-known principles of electric machine design to provide motor/generator operation without departing from the contemplated scope of the invention.

The electromagnetic coil assembly 12 is comprised of at least one loop of electrically conductive material, with a majority of the loop's length passing through the magnetic field provided by magnet array 11 in an orientation substantially perpendicular to the predominant orientation of the magnetic field generated by the magnet array, thereby assuring that passage of electric current along the conducting loop will provide a torque on magnet array 11, rotating cylinder 10, and other components fixed to the cylinder. The electrically conductive material is preferably copper or other good electrical conductor. The construction of electromagnetic coil assembly 12, including such details as material, turns count, wire size, operating voltage and current will be determined by the particular requirements to be satisfied by operation of the motor/generator, and are not limiting.

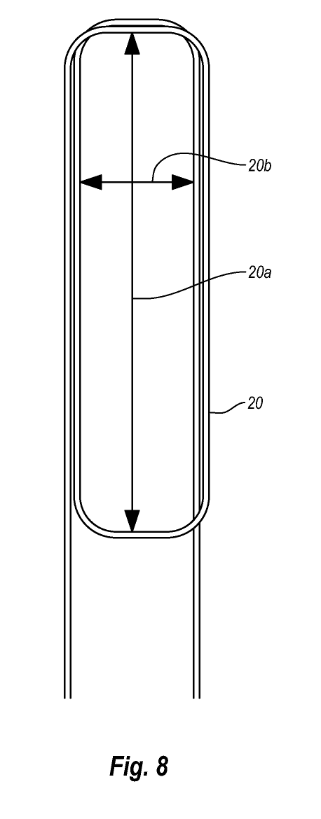

FIG. 8 depicts a schematic coil 20 of electrically conducting material such as copper wire that allows the flow of electrical current when its leads are connected to an external source of power (not shown) and which allows the flow of electrical current when subjected to a changing magnetic field and when its leads are connected to an external electrical load (not shown). The coil has major 20a and minor 20b inner dimensions, and comprises multiple turns of conducting material whose number and physical disposition vary according to the requirements of its particular use.

More particularly, while in the example shown in FIG. 8, the electromagnetic coil assembly 12 is constructed by winding a coil of copper wire less than two turns in order to simply illustrate how the coil is formed, in one embodiment, the coil is constructed by forming 72 turns of #22 gauge copper wire having a thin insulating layer into a coil. The coil has a major inner dimension 20b of approximately seven inches, a minor inner dimension 20a of one inch, and wire cross section dimensions of approximately 0.5 inches wide×approximately 0.25 inches deep. These dimensions are determined by electrical requirements and are not limiting to the practice of the invention.

In one embodiment, three coils 20, 21, 22 are formed using the technique described above and each comprise multiple turns of conducting material whose number and physical disposition vary according to the requirements of their particular use.

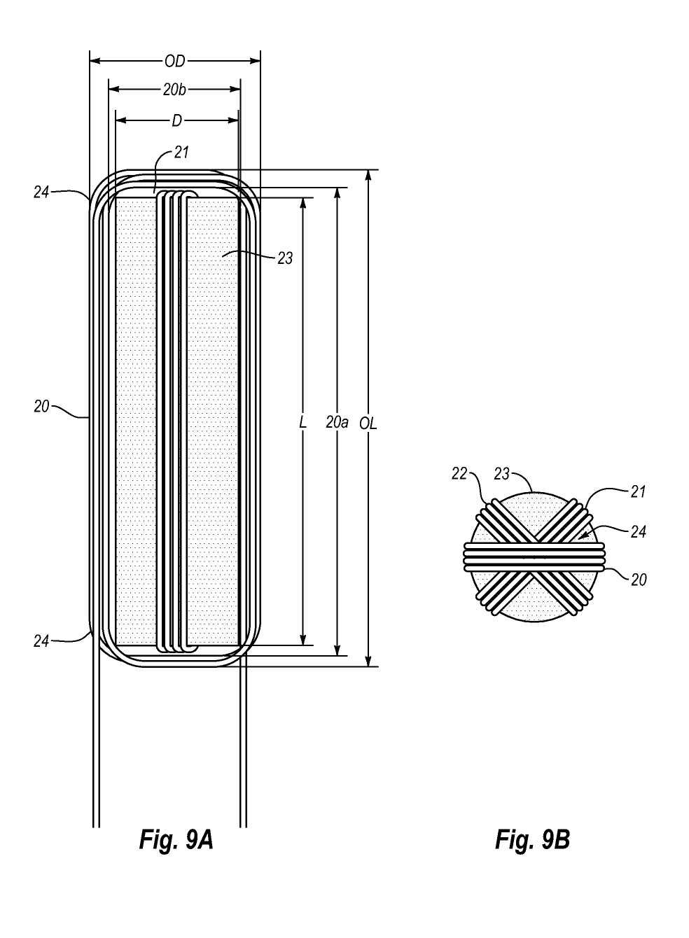

The coils 20, 21, and 22 are affixed to a supporting form 23 as depicted schematically in FIG. 9A, said supporting form having a length L which is slightly less than the major inner coil dimension 20a to allow said coils 20, 21, and 22 to be slipped over the form 23 for support. For clarity, in FIG. 9A, only two of the coils 20 and 21 are shown as being affixed to supporting form 23. Supporting form 23 has a diameter D approximately equal to the minor inner coil dimension 20b, again to allow said coils 20 and 21 to be slipped over and to rest upon the form for support 23.

As shown in FIG. 9B, coils 20, 21, and 22 are arrayed at approximately 120 degrees about the circumference of the supporting form 23, with their long axes 20b parallel to the Z coordinate axis, and interposed such that they pass over or under one another at two crossover regions 24 shown schematically in FIGS. 9A and 9B. Those skilled in the art will recognize this coil configuration as that of one type of three-phase motor/generator. The choice of number of phases or particulars of coil configuration is not limiting to the practice of this invention.

In one embodiment capable of performing aspects of the invention, when affixed to its supporting form 23, the coil assembly of coils 20, 21, and 22 exhibits an outer diameter OD of approximately 1.5 inches, this diameter being the sum of twice the minor coil thickness and the supporting form diameter D. This results in a radial clearance of 1.25 inches between the outer surface of the coil assembly (radius=0.75 inches) and the closest magnet surface (radius=2.0 inches).

Since the clearance radius (1.25 inches) along the X- and Y-axes exceeds the maximum radial geometric eccentricity (runout) of the rotating cylinder 10 projected into the X- and Y-axes when rotating about its inertial axis, it is apparent that no contact between the rotating cylinder 10 and the stationary electromagnetic coil assembly 12 can occur as a result of the rotating cylinder's 10 motion about its inertial rotational axis 6.

Because the rotating cylinder's 10 inertial rotational axis 6 is parallel to the Z-axis, there is no projected geometric eccentricity, or runout, along the Z-axis. The rotating cylinder 10 may therefore be fixed in position along the Z-axis without developing synchronous forces. Under the conditions contemplated in this embodiment, wherein the rotating cylinder 10 spins parallel to the Z-axis and is under the influence of gravity, it is both feasible and necessary to suspend the rotating cylinder 10 to counteract the tendency of gravity to otherwise pull it into contact with the stationary environment.

Suspension of the rotor along the Z-axis may be accomplished by a number of means. Although magnetic suspension is described in this embodiment, other means can be employed and magnetic suspension is not a limiting aspect of the invention.

Returning to FIG. 6, at the upper end of rotating cylinder 10 is fixed a lower levitation magnet 13 with its magnetic field oriented along the Z-axis. For convenience, we designate the north magnetic pole as facing upward, and the south magnetic pole as facing downward, in contact with the rotating cylinder 10. As described more fully below, the lower levitation magnet 13 is preferably composed of rare earth-based magnetic materials, although this composition does not limit this invention. The dimensions of lower levitation magnet 13 are determined by the weight of the rotating cylinder 10 to be levitated and by engineering convenience as to the space available for the component. Particular dimensions of the lower levitation magnet 13 are not limiting.

Disposed near lower levitation magnet 13 is upper levitation magnet assembly 14, which consists of two ring magnets 14a and 14b, and a support structure 14c that, in aggregate, attract lower levitation magnet 13 with a force equal to the weight of the rotating cylinder 10 and thereby position the rotating cylinder 10 at an equilibrium position on the Z-axis. Lower levitation magnet 13 and upper levitation magnet assembly 14 are designed by means well-known to the art to provide a net downward repulsion for slight cylinder position perturbations in the positive Z-axis direction, and a net upward attraction for slight cylinder position perturbations in the negative Z-axis direction, thereby maintaining the rotor at a desired height along the Z-axis. In accord with Earnshaw's Theorem, there is at least no restoring force caused by perturbations of the rotating cylinder 10 from the origin along either the X- or Y-axes, and therefore no functional equivalent of a bearing is provided by the magnetic suspension system described herein.

It will be apparent to those skilled in the art that functionally equivalent means of fixing the rotating cylinder's 10 Z-axis position while leaving its position along the X- and Y-axes unconstrained can be readily devised using mechanical means. In one embodiment, Z-axis position is determined by a flat disc mounted on the top of the rotating cylinder 10 running against a flat plate, while both surfaces are free to move with respect to one another in the X- and Y-axes, leaving the rotating cylinder 10 to spin unconstrained about its inertial rotational axis. It will also be apparent to those skilled in the art that an operable means of fixing the body's position along the Z-axis without providing the effect of a bearing in the X- and Y-axes would be the use of electrostatic fields to cause attraction between a nonrotating element fixed to the nonrotating environment, causing an attraction to a rotating element fixed to the rotating body, providing sufficient controlled force to locate the body at a preferred location along the Z-axis. The particular means of locating the rotating cylinder 10 in the Z-axis is not a limitation of the invention.

Although the rotating cylinder 10 described herein is not constrained to rotate about a particular geometric axis, it is necessary to provide, and this invention provides, a means of confining the rotating cylinder 10 within a defined region on the X- and Y-axes in order to prevent its eventual undesired contact with its nonrotating surroundings. Perturbations that might cause such an unintended and undesirable contact include motion of the environment due to seismic activity, change in the orientation of the rotating cylinder 10 with respect to gravity as a result of the movement of soil underlying the machine's support structure, and precession due to Earth's rotation. It is important that the means of confinement not employ forces synchronized with the rotating cylinder's 10 spin. Confining the rotating cylinder 10 within a defined region is facilitated by use of means to sense rotor position.

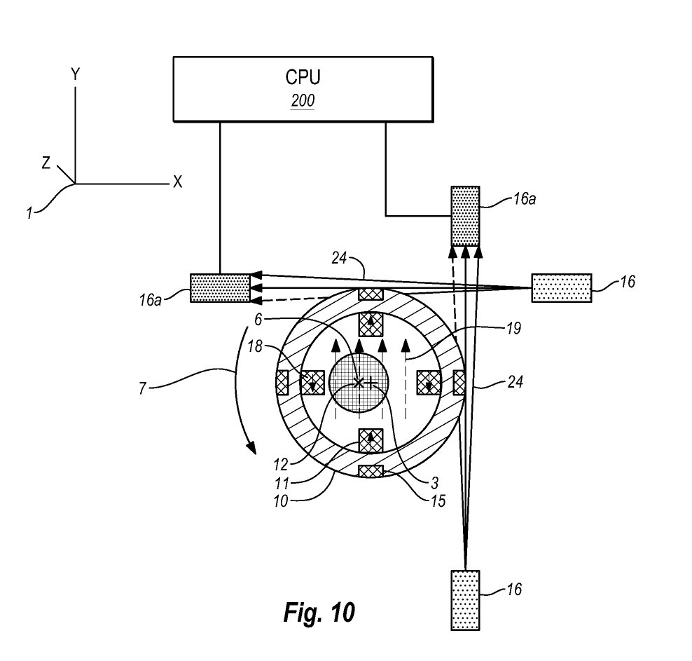

One example of a means for sensing the position of the rotating cylinder 10 is shown in FIG. 10, which depicts position sensor assemblies 16 that are disposed in pairs at the top and bottom of rotating cylinder 10 in both X- and Y-axes, for a total of four sensor assemblies. Each position sensor assembly 16 consists of a diode laser which emits a beam of light that is partially occluded by the rotating cylinder 10, the unoccluded light proceeding to a photosensitive detector 16a. Motion of the rotating cylinder 10 in either the X- or Y-axis is thereby detected by corresponding variations in the amount of light falling on the photosensitive detectors 16a. These sensors 16a are mounted stationary with respect to the rotating cylinder 10 and measure the rotating cylinder's 10 position as described below. Position sensors 16a are available in a variety of technologies: capacitance, inductance, optical ranging, and others, and the particular position sensor technology selected is not a limitation of this invention.

In this embodiment, optical sensors 16a measure the rotating cylinder's 16a position on the X- and Y-axes at both ends by detecting the rotating cylinder's 10 position-dependent occlusion of a beam of light 24 that is projected tangent to the cylinder's outer surface as shown in FIG. 9, and which impinges on a photodetector 16a. Suitable lasers include a wide range of electrically-driven diode lasers emitting light in the visible spectrum between 635 nm and 650 nm, such as the model LLP6501FS available from Lasermate Group, Inc., of Pomona, Calif. Suitable photosensitive detectors 16a include silicon photodiodes such as those available from Hamamatsu Corporation with offices in Bridgewater, N.J. It will be clear to those skilled in the art that the position sensing assemblies may be mounted such that they lie outside any possible position the rotating cylinder 10 might occupy, precluding contact between the sensors 16a and the rotating cylinder 10. By means well-known in the art, the position of the rotating cylinder 10 in the X- and Y-axes may be computed from position sensor data which is captured and sent to a computer including a processing unit 200 (CPU), which then performs a process to derive cylinder position control information.

In this embodiment, the rotating cylinder 10 is free to move anywhere within +and −0.35 inches on the X- and Y-coordinate axes, and it may do so by any combination of translation and tilt. It will be noted that this maximum excursion would not result in contact between the stationary electromagnetic coil assembly 12 and the moving magnet array 11, because the distance between these elements when the cylinder is at the X,Y origin is 1.25 inches, which is greater than the geometric radial runout of 0.25 inches and the permissible maximum position radial runout of 0.35 inches. The overall motion of the rotating cylinder 10 under these conditions comprises an eccentric runout of plus and minus 0.25 inches projected along the X- and Y-axes superposed upon other translations and/or tilts projected onto the X- and Y-axes, the sum of which is allowed to reach plus or minus 0.35 inches from the X,Y origin, thereby defining the region of normal operation of the rotating cylinder 10.

When the (CPU) identifies or detects sensor data captured by the sensor(s) 16a which indicate that the rotating cylinder 10 has exceeded its excursion limits, restoring forces may be applied by energizing electromagnetic actuators 17, which react upon positioning magnets 15 to move the rotating, rotating cylinder 10 back within its operating limits in the X- and Y-axes. Actuation forces may be applied in a manner that is not synchronous with the rotating cylinder's 10 rotation. The application of force to the rotating cylinder 10 will produce equal and opposite forces on the electromagnetic actuators and through them, on their supports. Actuation forces may be applied with their timing and amplitude tailored to avoid resonant frequencies of the actuators or their support structures, or of any natural vibrational mode of the rotating cylinder 10.

Continuous operation of the active control mechanism described above will allow the rotating cylinder 10 to spin about its inertial rotational axis while remaining within prescribed limits of physical location with respect to its surroundings. It will be further apparent that the rotating cylinder 10 described above exhibits a pronounced imbalance as evidenced by its apparent geometric spin eccentricity, yet its maximum rotation speed is limited only by its ability to withstand centrifugal forces induced by its rotation. Further, to the extent that the nominal 0.25 inch displacement of the inertial axis of rotation 6 from the rotating cylinder's geometric center may change over time, that displacement will be of no consequence until it reaches a magnitude of 0.35 inches, at which point it will occupy the maximum limits selected for the rotating cylinder's 10 position. Note that because the available clearance between the rotating cylinder 10 and adjacent stationary objects in this embodiment is 1.25 inches, a displacement of the inertial rotational axis 6 from the rotating cylinder's 10 geometric center of up to 1.25 inches could be accommodated by this invention.

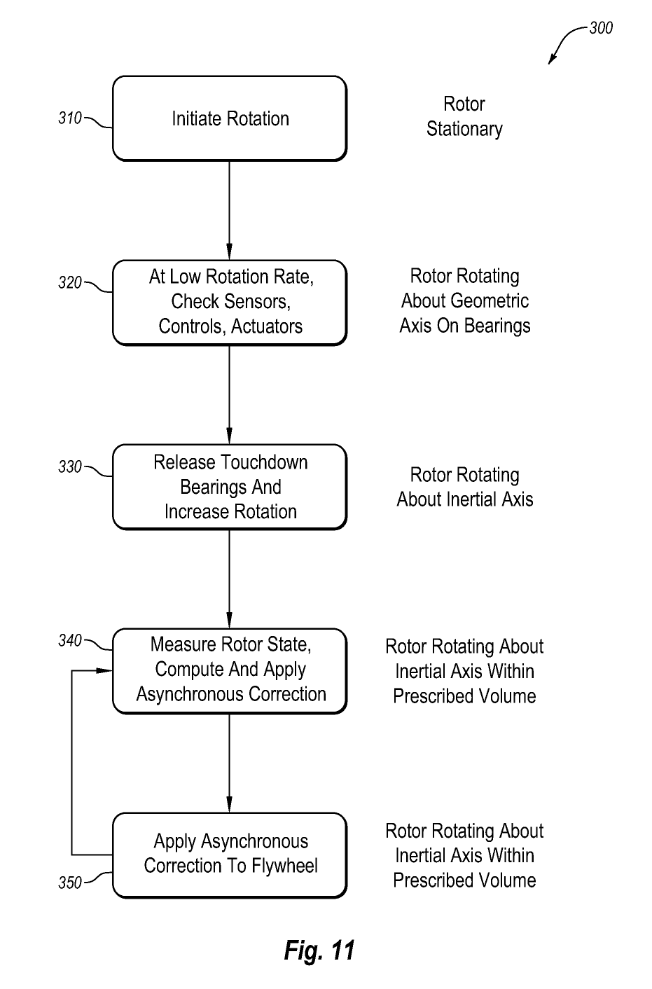

FIG. 11 is a block diagram which illustrates one embodiment of a method 300 for operating a rotating body, such as the rotating cylinder 10 of FIGS. 6-9. First, at step 310, the rotating cylinder 10 is rotated so as to transition from a static state to a controlled rotating state. Initially the body is static and supported on touchdown bearings of conventional mechanical means. An initial application of torque spins the rotating cylinder 10 to a desired rate of rotation while remaining in contact with the touchdown bearings, the rate being selected to be sustainable while operational checks of the apparatus and its control systems are performed at step 320, preferably by automated means. Various means for applying the initial rotational force on the rotating body may be used, and the particular method or means for initiating the rotation is not limited. Upon satisfactory conclusion of these checks at 320, a control system embodying the “bearingless” principles of the present invention is enabled, and at 330 the touchdown bearings are disengaged from the now-bearingless rotating body, and the rotating cylinder 10 is caused to accelerate to a desired spin rate. During this phase, and at all times during controlled bearingless operation, position sensor data are taken at step 340 and used for computation at the CPU 100 of the rotating cylinder's 10 position. Upon detection of a departure of the spinning cylinder 10 from a defined volume or region, repositioning commands are computed at the CPU 200 and applied to the rotating cylinder 10 through suitable effectors at step 350. The particular sequence and composition of events may differ as required by specific engineering needs without departing from the spirit of the present invention.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

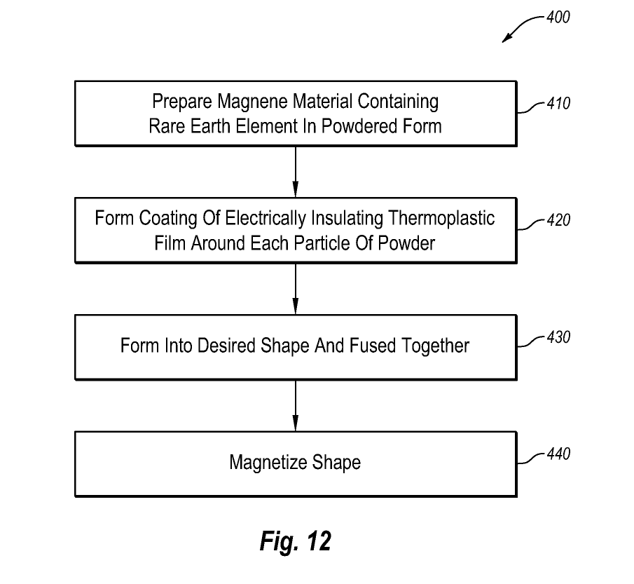

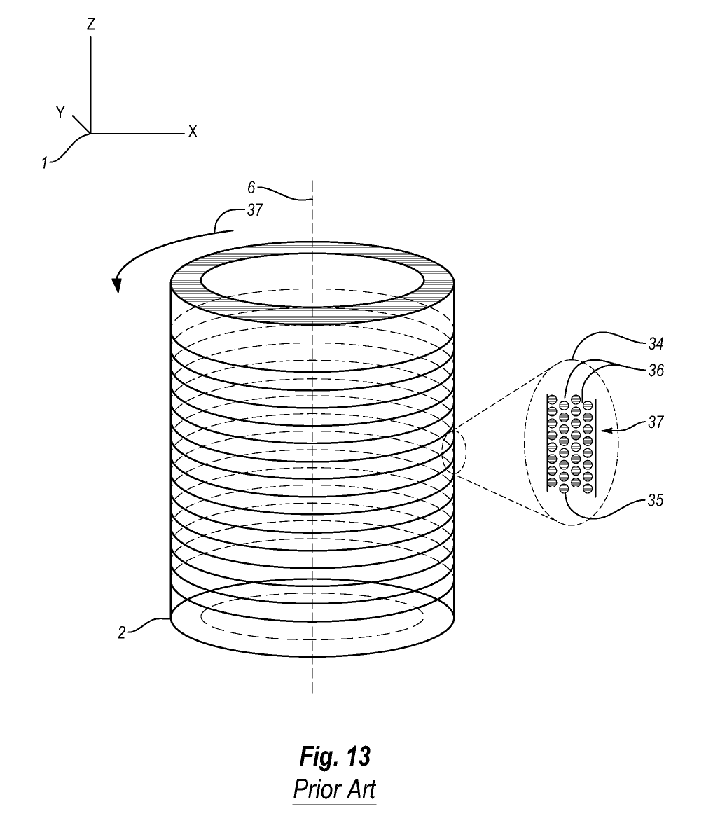

In one embodiment of this invention, one or more of the magnets 13, 14a, 14b, or 15 are formed of a magnetic material according to a method illustrated in FIG. 13. As shown in FIG. 12, the method 400 begins as a magnetic material containing at least one rare earth element is prepared in powdered form at step 410. Then, at step 420, the powder is processed so as to cause a coating of electrically insulating thermoplastic to form and adhere around substantially each particle of the powdered magnetic material. Then, at step 430, a mass of plastic-coated magnetic powder is formed into a desired shape and is then warmed to a temperature adequate to fuse adjacent thermoplastic layers together. The consolidated mass is subsequently magnetized at 440. The resulting permanent magnet, having substantially no contiguous regions of high electrical conductivity, exhibits an electrical resistivity greater than about 1 Ohm-cm. This permanent magnet is then employed in a flywheel and sustains eddy current power losses less than 1% of those which would be sustained by a rare earth magnet produced from uncoated precursor material.

It will be apparent to those skilled in the art that a wide variety of coating materials may be employed in this invention and that the details of their application to magnetic precursor materials may be similarly varied without departing from the spirit of this invention.

One advantage of using the specific process of producing the magnets described herein is that the resulting magnets have sufficiently low electrical conductivity so that they have reduced eddy currents as compared to the other magnets that are commonly used in the art.

In another embodiment of the invention, the rotating cylinder 10 is comprised of a material consisting of fibers that are disposed so as to maximize their resistance to breakage and to eliminate other failure modes of known kinetic energy storage devices. FIG. 13 illustrates on difficulty often encountered in rotating cylinders of the prior art. More specifically, as shown in FIG. 13, as the rotating body 2 rotates in the rotating direction 37 about the rotation axis 6, resulting centrifugal force places extreme stress the rotating body, particularly at the outermost radius of the rotor, with a radial stress that varies with position along a radius of the rotating body 2.

To resist these forces, so-called composite materials 37 have been used, such as those shown in the sectional view 34 of FIG. 13, in which strong fibers 35 are held by a matrix material 36. Examples include glass fiber/epoxy, graphite fiber/epoxy, and aramid fiber/epoxy composites. Such materials allow the rotating body to rotate at rates beyond those that can be achieved using metals or other non-composite materials. Major determinants of the properties of such composite materials include the ultimate tensile strength of reinforcing fiber materials, the strength of the bond that exists between the reinforcing fiber and its surrounding matrix material, the volume fraction of reinforcing fiber within a given volume of fiber-reinforced material, and the disposition of reinforcing fiber material within the matrix.

It is generally known in the art of composite materials 37 as applied to their use in rotating bodies that strong bonding between fiber and matrix materials is desirable because it elevates the composite material's fracture strength by enhancing the transfer of stresses applied to the composite article to the supporting fibers 35 within. At the point that shear stress as resolved along the fiber/matrix interface exceed that interface strength, the interface fails, degrading the fiber's 35 ability to support the composite 37 against applied stress.

In some instances in the art high-strength fibers are used in rotating components 2 that assemblies of fibers in which fibers cross over and contact one another, such as in yarns formed by twisting fibers together or in braids constructed of yarns, or in ropes constructed from yarns or braided yarns commonly exhibit values of ultimate tensile strength less than that of the same fiber material tested as a single fiber or as an assembly of parallel fibers with substantially no points of crossover contact.

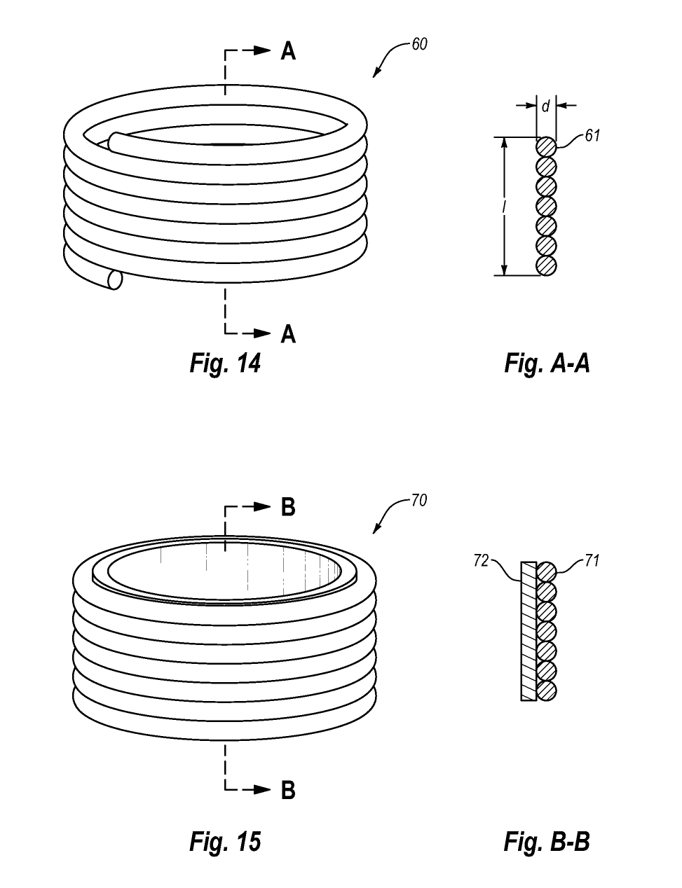

In an embodiment shown in FIG. 14, a rotating cylinder 60 is constructed in part from a single fiber 61 of a high-strength material having a diameter d being wound in a substantially circumferential disposition with respect to the desired axis of rotation 6, said fiber 6 being wound upon a suitable supporting mandrel to give a desired shape and mechanical support to the wound fiber material until the resulting rotating component has a length L with a thickness which is equal to diameter d. The fiber may optionally consist of lengths of fibers joined together in the lengthwise direction to constitute a required length. The fiber may optionally be coated with a lubricating material. The outer layer of fiber comprising the wound article may optionally exhibit an adhesive coating.

In another embodiment shown in FIG. 15, the rotating cylinder 70 is constructed in part from a material comprised of a plurality of single fibers 71 of high-strength material disposed longitudinally and adherently on up to all of the area of at least one side of a thin substrate layer 72 whose thickness is less than five times the diameter of the fibers disposed thereon. One or more of the fibers 71 may optionally consist of lengths of fibers joined together to constitute a required length. Optionally, the underlying substrate 72 may consist of lengths of substrate joined together to constitute a required length. The fibers 71 and/or substrate 72 may optionally be coated with a lubricating material.

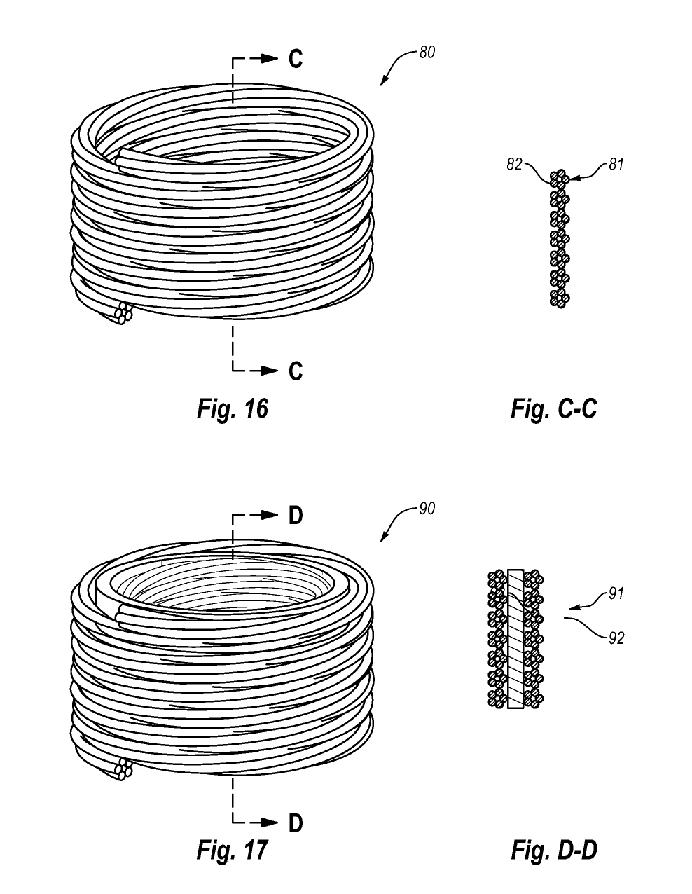

In still yet another embodiment shown in FIG. 16, the rotating cylinder 80 is constructed in part from a plurality of fibers 81 of a high-strength material gathered together as a yarn 82 and wound in a substantially circumferential disposition with respect to the desired axis of rotation, said plurality of fibers 81 being wound upon a suitable supporting mandrel to give a desired shape and mechanical support to the wound fiber material. The plurality of fibers 81 may optionally comprise a twisted yarn 82 or a yarn without twist. The yarn 82 may consist of lengths of fibers 81 joined together to constitute a required length. The yarn 82 may optionally be coated with a lubricating material.

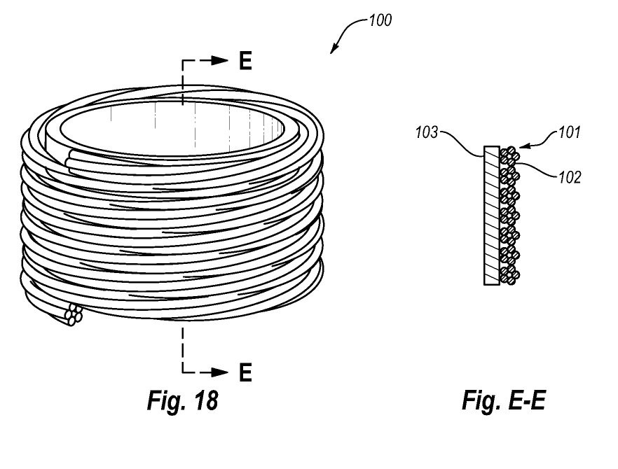

In an embodiment shown in FIG. 17, a rotating cylinder 90 is constructed in part from a material comprised of a plurality of bundles of single fibers 92 of high-strength material gathered together as a yarn 91, said bundles or lengths of yarn being disposed longitudinally and adherently on up to all of the area of both sides of a thin substrate layer 93 whose thickness is less than five times the diameter of the yarn bundles 91 disposed thereon. Alternatively, as shown in FIG. 18, the bundles or lengths of yarn 91 may be disposed longitudinally and adherently on only one side of the thin substrate layer 93.

One or more of the fibers or yarn lengths may optionally consist of lengths of fibers or lengths of yarn joined together to constitute a required length. Optionally, the underlying substrate 93 may consist of lengths of substrate joined together to constitute a required length. The fibers 92 and/or lengths of yarn 91, and/or the substrate 93, may optionally be coated with a lubricating material.

As may be understood by one of skill in the art, these embodiments provide means of improving the ability of the rotating cylinder 10 to withstand failure mechanisms known to limit the utility of rotating machinery, and/or reducing the cost of manufacture of rotating machinery, and/or increasing the duration of the useful operating life of rotating machinery. More particularly , the embodiments of the rotating cylinder p an increased portion of a high-strength fiber's ultimate tensile strength through use of fibers not incorporated into a bundle or yarn, said fibers being employed singly or disposed longitudinally on a thin substrate layer, such that successive overwrapped layers exhibit little or no mutual adhesion in a radial direction.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for rotating machinery, the system comprising:
a rotating body having an inertial axis of rotation;
a means for rotating the rotating body about its inertial axis; and
a means for supporting the rotating body while it rotates around its inertial axis without confining the rotating body to rotate around a defined geometric axis of rotation.

2. The system of claim 1, wherein the rotating body comprises a hollow cylinder.

3. The system of claim 2, wherein the means for rotating the rotating body comprises an array of magnets disposed around an inner circumference of the hollow cylinder and an electromagnetic coil assembly housed within the hollow cylinder which is capable of imparting a magnetic field on the array of magnets in order to rotate the rotating

4. The system of claim 3, wherein the array of magnets is arranged as a sparse Halbach magnet array.

5. The system of claim 3, wherein the electromagnetic coil assembly is comprised of a plurality of copper coils formed around a supporting form.

6. The system of claim 1, wherein the means for rotating the rotating body about its inertial axis and the means for supporting the rotating body while it rotates around its inertial axis do not contact the rotating body while it rotates around its inertial axis.

7. The system of claim 1, wherein the means for supporting the rotating body while it rotates around its inertial axis comprise a levitation magnet assembly.

8. The system of claim 1, further comprising a means for detecting a position of the rotating body while it rotates around its inertial axis.

9. A system for stabilization of rotating machinery, the system comprising:
a rotating body having an inertial axis of rotation, said rotating body having a displacement between its inertial axis of rotation and a defined geometric axis of rotation;
a means for rotating the rotating body about its inertial axis; and a means for supporting the rotating body while it rotates around its inertial axis without confining the rotating body to rotate around the defined geometric axis of rotation.

10. The system of claim 9, wherein the rotating body comprises a hollow cylinder.

11. The system of claim 10, wherein the means for rotating the rotating body comprises an array of magnets disposed around an inner circumference of the hollow cylinder and an electromagnetic coil assembly housed within the hollow cylinder which is capable of imparting a magnetic field on the array of magnets in order to rotate the rotating body.

12. The system of claim 11, wherein the array of magnets is arranged as a sparse Halbach magnet array.

13. The system of claim 11, wherein the electromagnetic coil assembly is comprised of a plurality of copper coils formed around a supporting form.

14. The system of claim 9, wherein the a means for rotating the rotating body about its inertial axis and the means for supporting the rotating body while it rotates around its inertial axis do not contact the rotating body while it rotates around its inertial axis.

15. The system of claim 9, wherein the means for supporting the rotating body while it rotates around its inertial axis comprise a levitation magnet assembly.

16. The system of claim 9, further comprising a means for detecting a position of the rotating body while it rotates around its inertial axis.

17. A method for stabilizing rotating machinery, the method comprising:
causing a rotating body having an inertial axis of rotation to rotate about its inertial axis of rotation, said rotating body having a displacement between its inertial axis of rotation and a defined geometric axis of rotation; and
supporting the rotating body while it rotates around its inertial axis without confining the rotating body to rotate around the defined geometric axis of rotation.

18. The method of claim 17, further comprising initiating the rotation of the rotating body by rotating the rotating body about its geometric axis of rotation for a period of time before the rotating body is caused to rotate about its inertial axis of rotation.

19. The method of claim 18, further comprising measuring the position of the rotating body and applying asynchronous correction to the position of the rotating body when it is determined that the rotating body is rotating outside a prescribed volume.

20. The method of claim 17, further comprising measuring the position of the rotating body and applying asynchronous correction to the position of the rotating body when it is determined that the rotating body is rotating outside a prescribed volume.
